(19) United States
(12) Patent Application Publication
(10) Pub. No.: US 2025/0133519 A1
(43) Pub. Date: Apr. 24, 2025

(54) WAVEFORM GENERATION AND DIGITAL UPSAMPLING IN A COMMUNICATIONS SYSTEM

(71) Applicant: Hughes Network Systems, LLC, Germantown, MD (US)

(72) Inventors: Shantharam Gurumani, Frederick, MD (US); Bala Subramaniam, Potomac, MD (US)

(21) Appl. No.: 18/492,045

(22) Filed: Oct. 23, 2023

(51) Int. Cl. H04W 56/00

(52) U.S. Cl. CPC H04W 56/004; H04W 56/0035

(57) ABSTRACT

A system can include a phase timing offset component that generates a first signal to indicate an offset of a first symbol from a reference signal and an accumulator component that combines the offset of the first symbol with a first phase increment based on the reference signal. The system can additionally include a memory that stores a first shaping parameter to modify a filter coefficient to be applied to the first symbol based on the first phase increment and an interpolator that modifies the first shaping parameter for the first phase increment to adjust for the offset of the first symbol.

### BACKGROUND

In a communications network that utilizes wireless communication links between transmitting and receiving stations, such as a satellite communications network or a terrestrial communications network, data from a baseband source can be translated into symbols in accordance with a selected symbol mapping technique. Waveforms that represent the symbols can then be shaped into a digital waveform that can then be upconverted to a carrier frequency, amplified, and transmitted through a communications channel for reception at a receiving station. Prior to conversion to a carrier frequency, the symbols may undergo processing that permits efficient use of the communications channel, increased signal quality, etc.

### BRIEF DESCRIPTION OF THE DRAWINGS

FIG. 1 is a diagram of an example communications system transmitting a signal to a satellite orbiting about the Earth.

FIG. 2 is a graph showing an example of root-raised cosine filtering of a first symbol and an effect of such filtering in a time domain.

FIG. 3 is a diagram of components of the example communications system of FIG. 1.

FIG. 4 is a flowchart for a process for symbol shaping in a communications network.

### DETAILED DESCRIPTION

In a wireless communications system, such as a terrestrial communications system, a satellite-based communications system, or a system that utilizes both terrestrial and satellite communication links, baseband data, e.g., binary digits, can be formatted into symbols. Symbols can then be modulated by a suitable modulator, converted to a radio, microwave, or millimeter wave carrier frequency, amplified, and transmitted through a communications channel to a receiving station. As used herein, a “symbol” means a time-varying electrical voltage that represents one or more binary digits of baseband data. For example, in a communication system that utilizes a Quadrature Amplitude Shift Key (QPSK) to encode baseband data, two bits of binary encoded data (e.g., 00, 01, 10, 11) can be formatted into one of four symbols that can be transmitted using phase variations (e.g., 0°, 90°, 180°, 270°) with respect to a carrier signal. In another example, in a communication system that utilizes a 16-quadrature amplitude modulation (e.g. 16-QAM), four bits of baseband data (e.g., 0000, 0001, 0010, etc.) can be formatted into one of 16 symbols each represented by a predetermined amplitude and phase (e.g., a first amplitude at a first phase, a second amplitude at a second phase, a third amplitude at a third phase, etc.) with respect to a reference carrier signal.

In some communication systems, prior to up-conversion of a symbol to a suitable carrier frequency, a symbol can be conditioned or shaped, such as according to a shaping parameter, so as to increase an amount of signal amplitude that is conveyed within an allotted symbol period and to decrease an amount of amplitude that is conveyed outside of the allotted symbol period. An absence of such conditioning or shaping of symbols can result in intersymbol interference, in which a portion of a first (previously) transmitted symbol interferes with a second (subsequently) transmitted symbol. In this context, a “shaping parameter” means a filtering parameter that operates to modify a coefficient of a shaping filter (e.g., a root-raised cosine filter, a Gaussian filter, an ideal low-pass filter, etc.) that can be applied to a symbol.

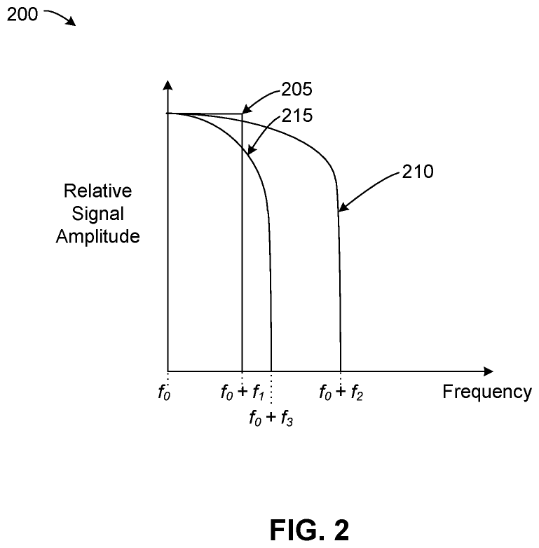

In an example, a symbol can be filtered utilizing a digital filtering technique, such as a root-raised cosine filter, in which symbol voltage levels at or near a center frequency of a carrier can be emphasized while symbol voltage levels spaced from the center frequency can be deemphasized. In the context of this disclosure, a root-raised cosine filter means an implementation of a low-pass Nyquist filter having a transfer function (H) that accords with expression (1) below:

$${H}_{R R C} ( ω ) = \sqrt[n]{\frac{( 1 + cos ( \frac{π ω}{2 {ω}_{c}} ) )}{2}} \qquad ( 1 )$$

where |ω|<2ω_{c}, ω_{c} represents the symbol rate (in radians), ω represents an instantaneous frequency (in radians) of the symbol during the sampling interval, and the index n represents a positive real number indicating the root (e.g., square root, cube root, or a noninteger root, etc.) of the radicand (e.g., 1+cos(πω/2ω_{c}))/2). Expression (1) can encompass numerous variations, such as variations that additionally specify a roll-off factor, which indicates a rate of decrease of symbol voltage level outside of a boundary of the low-pass Nyquist filter. An example of a benefit of symbol filtering via a root-raised cosine is given in FIG. 2.

In applying a digital filtering operation to a symbol waveform representing a symbol, a symbol waveform may be digitally sampled (e.g., upsampled) at a rate that includes a multiple of the symbol rate. For example, in digital sampling of a symbol having a symbol rate of 1.0 megahertz, a digital signal sampler may utilize a sampling rate of, for example, 10 megahertz. Such upsampling can be useful in rendering a digital representation of the symbol with reduced distortion with respect to the original (analog) representation of the symbol. In an example, upsampling can result in a signal-to-noise ratio of a transmitted signal of 30 decibels, 40 decibels, 50 decibels, etc. Following digital sampling (e.g., upsampling) of a signal waveform, a digital filter can be applied to a digital representation of the sampled symbol waveform that accords with, for example, the root-raised cosine filter as described in relation to expression (1). Other filters can be applied to a digital sample of a symbol waveform, such as a finite impulse response filter, a Gaussian filter, an ideal low-pass filter, etc. After applying a root-raised cosine filter or other suitable filtering technique, a digitally sampled symbol waveform can be converted to an analog symbol (e.g., via a digital-to-analog converter), modulated (e.g., via mixing the analog symbol with a complex sinusoid), amplified, and transmitted via a suitable antenna for receiving at a receiving station.

In some example communication systems, an integer relationship may exist between a symbol rate and a rate at which the digital samples of the symbol waveforms are converted back to an analog voltage prior to modulation on a carrier signal, amplification, and transmission of the carrier signal. In some examples, such integer relationships can result in efficient conversion of symbols to digital representations, shaping of the digital representations of the symbols, and conversion of the symbols back to an analog form. Accordingly, in some example communication systems, in which millions of symbols can be processed in a single second, hardware registers and hardware-based logic may be utilized to perform such operations.

However, it will be appreciated that such hardware-based implementation of digital sampling of symbols, symbol shaping (e.g., via root-raised cosine filtering, finite impulse response filtering, Gaussian filtering, etc.), and conversion to an analog form can render such systems inflexible with respect to communication systems that utilize varying symbol rates. For example, in a communication system that utilizes a symbol rate of 1.5 megahertz and a digital-to-analog converter that operates at 10 megahertz, each symbol waveform may be upsampled by a factor of 20 to provide 30 million samples per second. The number of samples can then be reduced by a factor of three, so as to accord with the 10-megahertz sampling rate of the digital-to-analog converter. This can represent an inefficient use of processing resources since the results of numerous computing operations (e.g., 20 million operations) may be discarded prior to digital-to-analog conversion.

In accordance with examples described herein, symbol shaping and upsampling in a communications network can be performed to realize the digital samples of a waveform at variable symbol rates in which symbol sampling, digital filtering (e.g., via a root-raised cosine filter, Gaussian filtering, etc.), and digital-to-analog conversion can occur in a manner that retains all, or at least substantially all, of the results of such computations. In an example, a system for symbol shaping and upsampling can be operated in a manner in which each digital sample of a symbol waveform is suitably filtered (e.g., via a root-raised cosine filter) and converted to an analog representation in a manner that retains substantially all upsampled and filtered digital samples of the waveform. In addition, such a system can accommodate a variety of symbol rates, upsampling rates, and rates at which digital samples of a waveform are converted from a digital representation to an analog representation (e.g., digital-to-analog conversion). In example implementations, a communications system can include a hardware implementation that combines shaping of symbols output from a symbol mapper, up-sampling, and timing adjustments that can accommodate timing changes that are based on, for example, relative motion of a transmitting station with respect to a receiving station.

In an example, a system can include a phase timing offset component that generates a first signal to indicate an offset of a first symbol from a reference signal. The system can additionally include an accumulator component that combines the offset of the first incoming symbol with a first phase increment based on the reference signal. The system can additionally include a memory that stores a first shaping parameter to modify a filter coefficient to be applied to the first incoming symbol based on the first phase increment. The system can further include an interpolator that modifies the first shaping parameter for the first phase increment to adjust for the offset of the first incoming symbol.

In an example, the reference signal can be a clock signal that initiates a sampling interval to sample a waveform representing the first symbol.

An example, the phase timing offset component can additionally generate a second signal to indicate a timing delay of a clock cycle from the clock signal.

In an example, the accumulator component can combine the offset of the first incoming symbol with the first phase increment of the reference signal into a digital word for storage by the memory.

In an example, the first shaping parameter can include an interpolated polyphase filter constant.

In an example, the polyphase filter constant can operate to reduce intersymbol interference between the first incoming symbol and a second incoming symbol.

In an example, the polyphase filter constant can determine a root raised cosine filter.

In an example, the first symbol can be a symbol from a 16-quadrature amplitude modulator.

In an example, the interpolator can interpolate between the first shaping parameter that is based on the first phase increment and a second shaping parameter that is based on a second phase increment.

In an example, the interpolator can implement a linear interpolation between the first shaping parameter for the first phase increment and a second shaping parameter for a second phase increment.

In an example, interpolator can implement Farrow interpolation between the first shaping parameter for the first phase increment and a second shaping parameter for a second phase increment.

In an example, the first shaping parameter can result in a signal-to-noise ratio of the first incoming symbol of at least 40 decibels.

In an example, a method can include generating a first signal to indicate an offset of a first incoming symbol from a reference signal. The method can additionally include combining the offset of the first incoming symbol with a first phase increment based on the reference signal. The method can additionally include storing a first shaping parameter to modify a filter coefficient to be applied to the first incoming symbol based on the first phase increment and interpolating the first shaping parameter for the first phase increment to adjust for the offset of the first incoming symbol.

In an example, the reference signal can be a clock signal that initiates a sampling interval to sample a waveform representing the first symbol.

In an example, the method can additionally include generating a second signal to indicate a timing delay of a clock cycle from the reference signal.

In an example, the first shaping parameter can include an interpolated polyphase filter constant.

In an example, the polyphase filter constant can operate to increase the signal-to-noise ratio of the first incoming symbol to at least 40 decibels.

In an example, the polyphase filter constant determines a root-raised cosine filter.

In an example, the first incoming symbol is a complex sinusoidal signal generated by a 16-quadrature amplitude modulator.

In an example, interpolating the first shaping parameter for the first phase increment can include linearly interpolating between the first shaping parameter that is based on the first phase increment and a second shaping parameter that is based on a second phase increment.

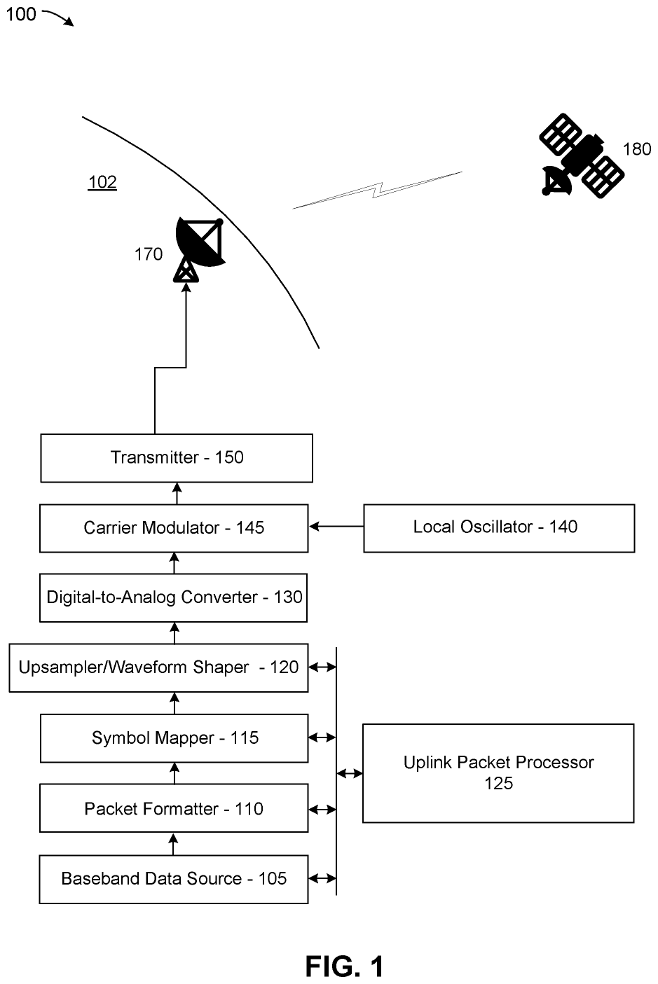

FIG. 1 is a diagram of an example communications system 100 transmitting a signal to a satellite orbiting about the Earth. As illustrated in FIG. 1, satellite 180 orbits the Earth 102 within the communications range of ground station antenna 170. Satellite 180 can be positioned in a geosynchronous orbit that permits ground station antenna 170 to be continuously oriented in the direction of satellite 180. In another example, satellite 180 may move relative to the surface of the earth 102, such as in a low Earth orbit or medium Earth orbit, at a distance of between 300 kilometers and 1200 kilometers above the surface of the Earth 102. In such an example, antenna 170 may represent an electronically scanned antenna having a main beam that is continuously or intermittently reoriented in the direction of satellite 180 so as to maintain a wireless communications link between antenna 170 and satellite 180. Antenna 170 may be of any suitable type, such as a parabolically-shaped antenna, or a two-dimensional phased array antenna that electronically scans an antenna beam in the direction of satellite 180.

In the example communications network of FIG. 1, antenna 170 may exchange wireless signals utilizing quadrature-phase and in-phase communication signals. In operations to transmit signals from antenna 170 to satellite 180, baseband data source 105 may generate binary digits that represent voice, text message content, multimedia content, or any other type of information. Uplink packet processor 125 can include a memory for storing program instructions that control the operations of baseband data source 105, packet formatter 110, symbol mapper 115, and upsampler/waveform shaper 120.

Baseband data source 105 may operate in a “packet” mode under the control of uplink packet processor 125. In the context of this disclosure, a “packet mode” of operation means a time-division-multiple-access (TDMA) communications mode in which transmitter 150 transmits during a specified interval. In an example, transmitter 150 may be allocated a transmit interval of 0.1 seconds during each second of a calendar day. Accordingly, in such an example, transmitter 150 may transmit a first packet during a first 0.1-second interval of a first second and may transmit a second packet during a second 0.1-second interval of a subsequent second. Such a scheme can permit satellite 180 to receive transmissions from multiple transmitters, which may be distributed across the surface of the Earth 102. In this context, a “packet” means a block or set of binary data. That is, a packet in the present context is a typical block or set of baseband data known for communications in a digital network. Accordingly, a packet can include a segment of multimedia content (e.g., video clip), a text message or group of text messages, a portion of a digitized voice message, a computer file or a subdivision thereof, or any other binary encoded information.

In an example, uplink packet processor 125 may track timing parameters to synchronize operations of Earth-based components of system 100 to accord with those of satellite 180, which may be in motion relative to antenna 170. Accordingly, in an example in which satellite 180 is in motion with respect to antenna 170, uplink packet processor 125 may access a memory that stores a satellite ephemeris (i.e., satellite position and/or trajectory data), which may include a table having position and velocity state information of satellite 180. Based on the satellite ephemeris, uplink packet processor 125 may adjust a transmit time of an allocated transmit interval of Earth-based components of system 100 so as to offset (i.e., delay or advance) a transmit interval so that transmissions from antenna 170 arrive at satellite 180 within the allocated TDMA transmit interval. In another example, in which Earth-based components of system 100 are installed in a moving vehicle (e.g., an automobile, a ship, etc.) that is in motion relative to satellite 180 (e.g., positioned in a geosynchronous orbit), uplink packet processor 125 can account for time differences resulting from ongoing changes in the position of antenna 170 relative to satellite 180.

Packets from baseband data source 105 may be formatted for wireless transmission to satellite 180. Such formatting can include insertion of a synchronizing word pattern that permits satellite 180 to obtain, for example, timing and/or symbol rate information. Packet formatter 110 may additionally insert error control coding, which permits satellite 180 to recover baseband data that may have been lost due to interference, noise, or other phenomenon in the communications channel between antenna 170 and satellite 180.

Symbol mapper 115 can operate to map formatted packets from packet formatter 110 into symbols in accordance with a selected formatting technique. For example, packet formatter 110 may utilize 16-quadrature amplitude to encode formatted baseband data from packet formatter 110 in which two bits of binary encoded data (e.g., 00, 01, 10, 11) can be formatted into one of four phase-encoded symbols. In another example, in a communications system that utilizes 16-quadrature amplitude modulation, four bits of formatted baseband data from packet formatter 110 (e.g., 0000, 0001, 0010, 0011, etc.) can be formatted into one of 16 amplitude and phase encoded amplitude, a third amplitude, etc.) with respect to a carrier signal transmitted by transmitter 150. In an example, symbol mapper 115 can generate symbols representing data from baseband data source 105 at a symbol rate of between 15 megahertz and 200 megahertz.

Symbols from symbol mapper 115 can be sent to upsampler/waveform shaper 120, which can operate to sample symbol waveforms from symbol mapper 115. In an example, upsampler/waveform shaper 120 operates to sample waveforms at a rate of between, for example, four times and 20 times the rate at which symbols are generated by symbol mapper 115. In an example, symbol mapper 115 can generate symbols at a rate of 24 megahertz to sample by upsampler/waveform shaper 120 at a rate of 250 megahertz. Accordingly, for each symbol waveform, upsampler/waveform shaper 120 generates approximately 10 samples. Upsampler/waveform shaper 120 additionally operates to filter the digital samples of a waveform generated by symbol mapper 115. In the example of FIG. 1, upsampler/waveform shaper 120 can apply a root-raised cosine filter to digital samples of a waveform as described in reference to expression (1). Other filters can be applied to digital samples of waveform, such as finite impulse response filters, Gaussian filters, ideal low-pass filters, etc.

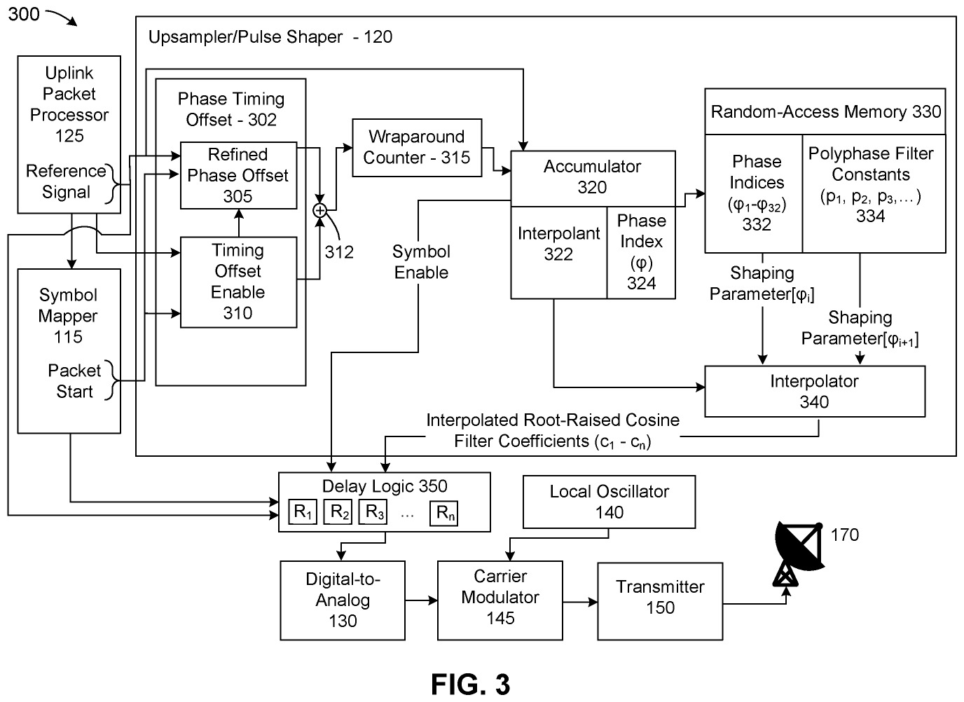

As described further in reference to FIG. 3, upsampler/waveform shaper 120 can apply polyphase filtering, for example, to provide root-raised cosine filtering coefficients. Root-raised cosine filtering coefficients resulting from interpolated polyphase filtering constants can be derived for digital samples of a waveform output from symbol mapper 115 at intervals between samples. In the context of this disclosure, “polyphase filtering” means any filter that operates to determine or estimate a value of signal (i.e., a voltage level) in between two or more sampling intervals. In an example, polyphase filtering can accurately estimate the value of a sample of a symbol waveform, over a sampling interval that approximates (e.g., closely approximates) the actual (e.g., analog) value of the symbol waveform. In an example, based on upsampler/waveform shaper 120 sampling a symbol at a first time interval (T₁) of 25 nanoseconds and at a second time interval (T₂) of 50 nanoseconds, polyphase filtering applied by upsampler/waveform shaper 120 can provide an estimated value of a digital sample of a waveform at times in between the first sample and the second sample, such as at 30 nanoseconds (T₁+5 nanoseconds), 35 nanoseconds (T₁+10 nanoseconds), 40 nanoseconds (T₁+15 nanoseconds). A polyphase filter may utilize filter constants, which may be operate as coefficients of a polynomial expression, which operate to construct a mathematical function that approximates a portion of a symbol (e.g., a symbol from symbol mapper 115) in between sampling intervals. Thus, in reference to FIG. 3, polyphase filtering can be utilized by upsampler/waveform shaper 120 to provide interpolated coefficients of a root-raised cosine filter that can be customized in real time to accommodate varying symbol rates from symbol mapper 115 as well as accommodating varying input sample rates of digital-to-analog converter 130.

In an example, via polyphase filtering of digital samples of a waveform at an increased rate, a signal-to-noise ratio, which, in this context, means a difference between a polyphase filtered digital sample and an actual (analog) value of a signal waveform at a sampling interval, can be increased to a specified signal-to-noise ratio. Thus, in an example, a first signal may be polyphase filtered utilizing a sampling rate of 15 samples per symbol to result in a signal-to-noise ratio of 30 decibels. In another example, the first signal may be polyphase filtered utilizing a sampling rate of 25 samples per symbol to result in a signal-to-ratio of 40 decibels.

Digital-to-analog converter 130 operates to receive digital samples of a waveform from upsampler/waveform shaper 120 and to convert the digital samples of the waveform from a digital form (e.g., expressed in binary digits) to an analog voltage (e.g., expressed as a time-varying voltage). Analog voltages from digital-to-analog converter 130 can be sent to carrier modulator 145 to be mixed (e.g., multiplied) with an output signal from local oscillator 140. In an example, local oscillator 140 may operate at a frequency of between five and 50 gigahertz. In an example, carrier modulator 145 generates a quadrature-phased voltage signal and an in-phase signal in response to quadrature-phase and in-phase voltages from local oscillator 140. Quadrature-phase and in-phase voltage signals can then be sent to transmitter 150 for coupling to antenna 170.

FIG. 2 is a graph showing an example 200 of root-raised cosine filtering of a first symbol and an effect of such filtering in a frequency domain. In FIG. 2, the vertical axis represents an idealized relative signal amplitude of a modulated symbol, and the horizontal axis represents a relative measure of the frequency spectrum. In FIG. 2, f₀ represents a carrier frequency, and f₁ represents a portion of the frequency spectrum utilized to transmit the first symbol, such as from transmitter 150. In an example, rectangular shape 205 represents specified signal amplitude at a frequency of f₀+f₁. At a frequency of f₀+f₁, the signal amplitude of the first symbol falls to zero (or to another negligible value).

Curve 210 indicates a roll-off (as defined above) as a function of frequency of the signal amplitude of the first symbol based on the first symbol being transmitted without root-raised cosine filtering. As illustrated in FIG. 2, significant signal amplitude of the first symbol is present until a frequency of f₀+f₂. Accordingly, a second transmitted symbol, which may occur at a frequency that is adjacent or proximate to f₀, may be impaired (e.g., interfered with) by the signal represented by curve 210.

In contrast to curve 210, curve 215 represents a first symbol transmitted with root-raised cosine filtering. As shown in FIG. 2, the signal amplitude is substantially confined within f₀+f₃, which represents a reduced portion of the frequency spectrum. Accordingly, a second transmitted symbol, which may occur at a frequency that is adjacent or proximate to f₀, would undergo less impairment (e.g., interference) in response to a reduced amount of signal amplitude from the first symbol.

FIG. 3 is a diagram of components 300 of the example communications system of FIG. 1. The example of FIG. 3 can operate to execute a filtering operation (e.g., under the control of uplink packet processor 125) utilizing timing parameters of incoming symbols (e.g., from symbol mapper 115). Adjusted timing parameters can be utilized in a polyphase filtering process that estimates, via generating a polynomial having coefficients that describe portions of the symbol in between symbol sampling intervals, coefficients of a root-raised cosine filter. In an example, polyphase filter constants can be utilized to interpolate between a set of fixed constants that describe the root-raised cosine filter. An interpolant used in an interpolation process can then be used to modify root-raised cosine filter coefficients that can be applied to output symbols from symbol mapper 115 (e.g., at suitable time intervals controlled by delay logic component 350 via a symbol enable output from accumulator 320). Modified root-raised cosine filter coefficients can operate to shape symbols from symbol mapper 115. Accordingly, via interpolation between adjacent polyphase filter constants, a root-raised cosine filter can be generated that results in a time-varying analog voltage that approximates, with increased fidelity, a model root-raised cosine symbol. Digital samples of a waveform output from symbol mapper 115 can thus be controllably delayed (e.g., via delay logic component 350 responsive to a most significant bit (MSB) output from wraparound counter 315), filtered via root-raised cosine filtering, converted to an analog representation, amplified, and transmitted. Transmitted signals can include decreased distortion (e.g., symbol impairment) and/or increase the signal-to-noise of a transmitted signal to, for example, −30 decibels, −40 decibels, −50 decibels, etc.

In the example of FIG. 3, symbol mapper 115 can operate to map formatted packets from packet formatter 110 (of FIG. 1) into symbols in accordance with a selected formatting technique, (e.g., quaternary phase shift modulation, 16-quadrature amplitude modulation, etc.). In the example of FIG. 3, symbol mapper 115 can format baseband data from packet formatter 110 into one of four symbols that can be transmitted using voltages having phase variations with respect to a carrier signal. Symbol mapper 115 can output a packet start signal, which may initiate logic processes within phase timing offset component 302, which includes refined phase offset component 305 and timing adjustment enable component 310.

In the example of FIG. 3, based on a received packet start signal from symbol mapper 115, refined phase offset component 305 can operate to adjust timing of incoming symbols to accord with a transmit interval allotted to example communications system of FIG. 1. Accordingly, based on components 300 being installed in a moving vehicle, refined phase offset component 305 can operate to offset (e.g., delay or advance) timing of symbols from symbol mapper 115. In an example, refined phase offset component 305 can operate to incrementally adjust timing of the phase of symbols generated by symbol mapper 115. Refined phase offset component 305 can implement logic that includes a counter that provides a timing increment in relation to a reference signal from a reference signal, such as a reference signal from uplink packet processor 125. In an example, reference signal from uplink packet processor 125 outputs a signal at a rate of 250 megahertz. In an example, the reference signal from uplink packet processor 125 can be utilized as a reference signal to control timing of all operations executed by upsampler/waveform shaper 120.

In the example of FIG. 3, refined phase offset component 305 can provide a phase increment utilizing a comparator that compares the reference signal with the packet start signal from symbol mapper 115. Based on the reference signal from uplink packet processor 125 being delayed with respect to the packet start signal from symbol mapper 115, the comparator of refined phase offset component 305 can add a suitable phase offset so as to account for a difference between the reference signal with the packet start symbol from symbol mapper 115. In an example, refined phase offset component 305 can provide offsets in increments of 1.0 hertz, 2.0 hertz, 5.0 hertz, etc. In the example of FIG. 3, refined phase offset component 305 can provide refined phase adjustments to provide a timing offset over multiple clock cycles of the reference signal from uplink packet processor 125.

In an example, a phase offset provided by refined phase offset component 305 can be based on an output signal from timing adjust enable component 310. In an example, timing offset enable component 310 can operate to determine whether the number of phase increments from refined phase offset component 305 are enough to delay the packet start signal from symbol mapper 115 to align with the reference signal from uplink packet processor 125. In an example, the reference signal from uplink packet processor 125 can be a clock signal. In an example, a number of phase increments can be determined by uplink packet processor 125 based on determining the ephemeris of satellite 180 or another indication of the position, or expected position, of satellite 180. In another example, a number of phase increments can be determined by analyzing, via program steps executed by uplink packet processor 125, time delays utilized in past TDMA transmissions and adding an expected offset based on an updated position of antenna 170 with respect to a receiving station. In an example, based on an aggregate number of phase increments from refined phase offset component 305 being too few to align the packet start signal with the reference signal, e.g., a clock signal, from uplink packet processor 125, timing offset enable component 310 can maintain a state of an output signal indicating that refined phase offset component 305 is to continue to provide phase adjustment during subsequent reference signal (e.g., clock) periods. In an example, phase adjustments can be attained over successive clock cycles as indicated by the reference signal from uplink packet processor 125.

Based on a phase increment from refined phase adjustment component 305 being large enough to align the packet start symbol from symbol mapper 115 with the reference signal from uplink packet processor 125, timing offset enable component 310 can disable the state of the output signal indicating that refined phase offset component 305 is not to continue to provide phase offset over a succeeding clock period.

In an example, timing offset enable component 310 can output a signal to reset refined phase offset component 305 to a “0” value to indicate that refined phase offset component 305 is to reset a phase offset counter to “0” upon receipt of the reference signal. In an example, timing offset enable component 310 can determine a refined phase offset value, and whether a signal to reset refined phase adjustment of component 305 based on a ratio between the rate of digital samples of a waveform incoming from symbol mapper 115 (as indicated by the packet start signal) and a symbol sampling rate as indicated by the reference signal. Thus, in an example, refined phase offset component 305 and timing offset enable component 310 can cooperate to provide coarse and fined alignment between the reference signal from uplink packet processor 125 and the packet start signal from symbol mapper 115.

In an example, timing offset enable component 310 can determine whether to advance or to delay the phase of a symbol from symbol mapper 115 based on time differences resulting from changes in the position of antenna 170 with respect to satellite 180. In an example, in response to Earth-based components of system 100 being in motion with respect to satellite 180, timing offset enable component 310 can delay or advance the phase of a symbol so that the symbol can arrive at satellite 180 within an allocated (TDMA) transmit interval. In other examples, in response to local clock drift, estimated propagation delays attributable to variations in atmospheric conditions (e.g., air density) phase timing offset component can adjust signal transmission timing so that signals transmitted from communication system 100 arrive at satellite 180 within an allotted TDMA timeslot.

In an example, outputs of refined phase offset component 305 and timing offset enable component 310 can be aggregated by combiner 312 to generate a 24-bit word that describes, for example, the sum of the timing offset to be applied to symbols from uplink packet processor 125. In the example of FIG. 3, such timing delays can be input to wraparound counter 315. Wraparound counter 315 can execute a modulo-23 arithmetic operation in which, based on wraparound counter 315 exceeding 24 bits, wraparound counter 315 restarts beginning at a binary zero. For example, in response to wraparound counter 315 being an eight-bit counter having a saturation value of 255 (binary 11111111), an additional three-bit value from combiner 312 causes wraparound counter 315 to include a new value of three (binary 00000011). Overflow of wraparound counter 315 (e.g., saturating beyond a specified bit length and returning to zero) can indicate that a complement (e.g., a full complement) of digital samples of a waveform representing a first symbol from symbol mapper 115 have been conveyed to delay logic component 350. Responsive to an indication that enough samples of a waveform representing a first symbol have been output from symbol mapper 115, a second symbol can be output from symbol mapper 115 for input to delay logic component 350. In the example of FIG. 3, the most significant bit (MSB) of wraparound counter 315 can be utilized to indicate that the second symbol from symbol mapper 115 is being generated by the symbol mapper.

In an example, outputs from wraparound counter 315 can be sent to accumulator 320. In an example, accumulator 320 can operate as a register having a width of, for example, 24 bits in which a first specified number of bits indicate phase index (φ) 324, which can represent an approximate phase of symbols from symbol mapper 115. A second specified number of bits included in accumulator 320 can represent a refined phase of symbols from symbol mapper 115 that specify a phase offset from phase index (φ) 324. In an example, the five bits of greatest significance (e.g., the most significant bits) from accumulator 320 can represent phase index (φ) 324 of the incoming symbols and 18 bits of lesser significance (e.g., the least significant bits) can indicate interpolant 322. Interpolant 322 can specify a more refined phase expressed as an offset from phase index (φ) 324. In an example, a single bit (e.g., bit 24) within accumulator 320 can be utilized to indicate presence of a second or new incoming symbol from symbol mapper 115 in response to saturation of wraparound counter 315. Accordingly, in an example, the five bits of greatest significance from accumulator 320 can represent 32 (i.e. 25) possible values of phase index (φ) 324, with more refined phase increments of 262,144 (i.e., 218) being utilized to express a number of phase increments from phase index (φ) 324. Thus, in a specific example, in which accumulator 320 utilizes five bits (e.g., bit positions 20-24 to indicate an approximate phase, a first five-bit approximate phase can indicate a “17” (e.g., 10001 at bit positions 20-24), a second refined approximate phase can indicate a refined phase increment of 3265 (e.g., 110011000001 at bit positions 2-19) relative to the five-bit phase index (φ) of 10001. The more refined phase value can then be represented as a 23-bit word (e.g., bit positions 2-24) of 00000011001100000110001. In an example, accumulator 320 operates at a clock speed of 250 megahertz, which indicates that approximate and refined phase timing parameters are received by accumulator 320 at increments of 4.0 nanoseconds.

Outputs from accumulator 320 can be sent to random-access memory 330. In the example of FIG. 3, random-access memory 330 can store a 32-row table in which each row identifies one of 32 phase indices (i.e., φ₁-φ₃₂). Random-access memory 330 can additionally store polyphase filter constants (i.e., p₁, p₂, p₃, etc.) that operate to interpolate root-raised cosine filter coefficients that can be applied to symbols transmitted from symbol mapper 115 to delay logic component 350. Accordingly, random-access memory 330 includes entries that accord with 32 rows in which each row includes 36 polyphase filter constants. Thus, contents of random-access memory 330 can be summarized in Table I, below:

| Phase Index (φ) - 332 | Polyphase Filter Constants - 334 |
|---|---|
| 00001 | p₁, p₂, p₃, . . . , p₃₆ |
| 00010 | p₃₇, p₃₈, p₃₉, . . . , p₇₂ |
| 00011 | p₇₃, p₇₄, p₇₅, . . . , p₁₀₈ |
| . . . | . . . |
| 11111 | p₁₁₁₇, p₁₁₁₈, p₁₁₁₉, . . . , p₁₁₅₂ |

In Table I, each polyphase filter constant (e.g., p₁, p₂, p₃, . . . , p₃₂) includes 12-bit resolution although filter coefficients of other resolutions (e.g., 8-bit resolution, 10-bit resolution, 16-bit resolution, etc.) can be utilized. In an example, polyphase filter constants p₁-p₁₁₅₂ are loaded into random-access memory 330 prior to a first symbol being generated by symbol mapper 115.

Accordingly, random-access memory 330 operates to store polyphase filter constants for each of, for example, 32 phases of a symbol generated by symbol mapper 115. Polyphase filter constants can be utilized to interpolate between two adjacent phase indices so as to provide adjusted root-raised cosine coefficients that are determined in response to the total phase of a symbol from symbol mapper 115. It will be appreciated that the capability for such interpolation can (e.g., with a high degree of precision) provide symbol shaping (e.g., root-raised cosine shaping) of symbols in accordance with a selected filter. Although random-access memory 330 stores polyphase filter constants 334 that provide root-raised cosine filtering of symbols from symbol mapper 115, in another example, different polyphase filter constants can be utilized to provide filtering other than root-raised cosine filtering, such as Gaussian filtering, finite impulse response filtering, ideal low-pass filtering, etc.

It will be appreciated that polyphase filter constants can be interpolated to generate symbol filtering coefficients (e.g., root-raised cosine filtering coefficients) at various intervals. Accordingly, in a specific example, for polyphase filtering constants suitable for symbol filtering at 1.0 megahertz (e.g., filtering constants that can be applied at intervals of 1.0 microseconds), various numbers of interpolants can be utilized between the sampling intervals. In an example, 10 interpolants can be utilized, thus generating 10 root-raised cosine filter coefficients at 10 intervals between each sampling interval. In another example, 17 interpolants can be utilized, thus generating 17 root-raised cosine filter coefficients at 17 separate intervals between each sampling interval. Accordingly, the use of polyphase filtering provides the capability to upsample, at any suitable upsampling rate, a symbol from symbol mapper 115.

In the example of FIG. 3, interpolator 340 can receive an output from random-access memory 330 that includes a first shaping parameter at a first phase index (φᵢ) and a second shaping parameter at a second phase index (φᵢ₊₁). A shaping parameter can operate to modify a coefficient of a shaping filter (e.g., a root-raised cosine filter, a Gaussian filter, an ideal low-pass filter, etc.) that can be applied to a symbol. Thus, in the example of FIG. 3, a first shaping parameter can be represented by a first set of polyphase filtering constants (e.g., p₁, p₂, p₃, . . . , p₃₆). Based on the value of interpolant 322, interpolator 340 can operate to interpolate between a first set of polyphase filtering constants (e.g., p₁, p₂, p₃, . . . , p₃₆) and a second set of polyphase filtering constants (e.g., p₃₇, p₃₈, p₃₉, . . . , p₇₂). Interpolants representing offset symbol phases can then be used as coefficients of a root-raised cosine filter that can be applied to symbols transmitted from symbol mapper 115 to delay logic component 350. In an example, interpolation between first and second sets of polyphase filtering constants can be executed in accordance with expression (3) below:

$${c}_{i} = ( 1. - interpolant ) * {a}_{1} [ i ] + interpolant * {b}_{1} [ i ] \qquad ( 3 )$$

In expression (3), “interpolant” corresponds to an 18-bit value from accumulator 320. The value a₁[i] of expression (3) represents a polyphase filter constant at a first phase index (φᵢ). The value b₁[i] represents a polyphase filter constant at a second phase index (φᵢ₊₁). The interpolant of expression (3) can indicate a phase offset that lies in between the first and second phase indices. In an example, expression (3) can be computed for each polyphase filtering constant (e.g., 36 constants), which operates to adjust each root-raised cosine filter coefficient suitable for a symbol phase offset represented by the 18-bit interpolant from accumulator 320. Accordingly, via expression (3) interpolated polyphase filter constants can be utilized to determine coefficients of a root-raised cosine filter that can be applied by delay logic component 350, e.g., in response to a symbol delay output from accumulator 320, to symbols from symbol mapper 115.

Although expression (3) uses linear interpolation, in other examples, interpolator 340 can utilize another interpolation technique, such as Farrow interpolation, which can include piecewise polynomial interpolation to compute root-raised cosine or other filter coefficients. Farrow interpolation can utilize a technique, e.g., Horner's technique, which operates to compute a polynomial with only multiplications and additions. In another example, interpolator 340 can utilize Lagrangian interpolation to find a polynomial of a relatively low degree that intersects a given set of digital samples of a waveform from symbol mapper 115.

Interpolated filter constants computed via interpolator 340 computed via expression (3), for example cᵢ, can be sent from interpolator 340 to delay logic component 350. Delay logic component 350 may operate under the control of a symbol enable output from accumulator 320, which operates to delay logic component 350 from accepting symbols from uplink packet processor 125. In an example, delay logic component 350 includes 36 registers that operate to receive a symbol and to apply interpolated root-raised cosine coefficients (c₁ . . . . c_{N}) to each of the 36 registers. Sampled symbols of a waveform can be shifted in a time sequence through each register (R₁, R₂, R₃, . . . , R_{N}) based on signals from a reference signal from uplink packet processor 125. At each clock interval, a symbol from symbol mapper 115 can be filtered utilizing a suitable root-raised cosine filter that has been adjusted or tailored utilizing interpolated polyphase filter constants.

After delay logic component 350 applies root-raised cosine filtering to incoming symbols from symbol mapper 115, the filtered symbols can be converted from a digital representation to an analog representation via digital-to-analog converter 130. Analog representations of filtered symbols can be sent to carrier modulator 145, which performs a suitable carrier modulation technique based on output signals from local oscillator 140. In the example of FIG. 3, local oscillator 140 applies a complex sinusoidal signal at a carrier frequency. Suitable carrier modulation techniques can include quadrature-phase and in-phase carrier modulation, amplitude modulation, frequency modulation, etc.). Modulated carrier signals can then be sent to transmitter 150 and transmitted through antenna 170.

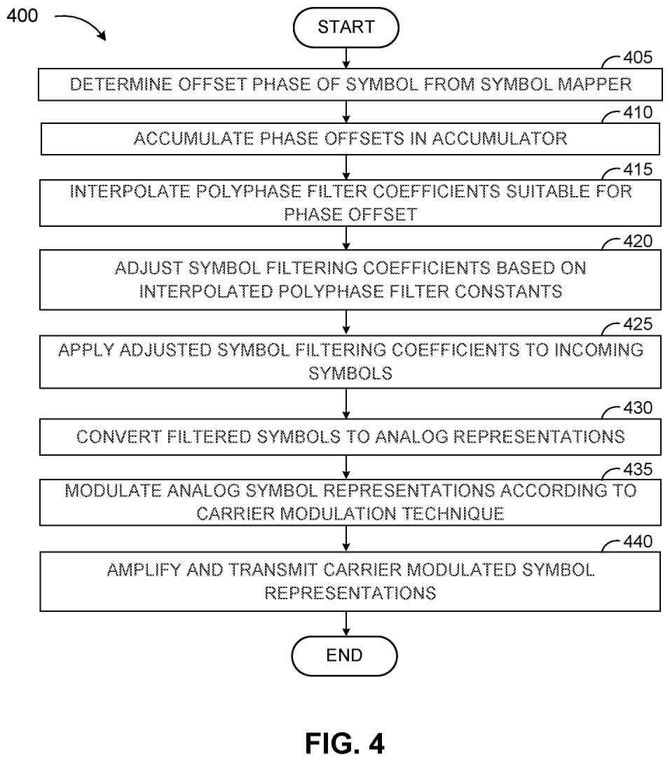

FIG. 4 is a flowchart for a process 400 for symbol shaping in a communications network. The process 400 of FIG. 4, which can be performed utilizing the components of FIG. 3 based on instructions executed by uplink packet processor 125, operates to determine an offset phase of a symbol from a symbol mapper. An offset phase can include coarse and refined alignment between the reference signal from uplink packet processor 125 and a packet start signal from symbol mapper 115. An offset phase can be expressed using a binary digital word stored in accumulator 320, which indicates, for example, a five-bit phase index and an 18-bit value of an interpolant that specifies a value to be interpolated between five-bit phases stored in random-access memory 330. Random-access memory 330 may additionally store polyphase filter constants that operate to modify a root-raised cosine filter that can be applied to symbols from symbol mapper 115. Filtered symbols can be converted from a digital representation to an analog representation and modulated utilizing a complex sinusoid from local oscillator 140. Modulated carrier signals can then be amplified and transmitted to satellite 180, for example, via antenna 170.

Process 400 begins at block 405, which includes determining a phase offset of a symbol transmitted by symbol mapper 115. In an example, symbol mapper 115 operates to map symbols representing binary digits, such as one binary digit, two binary digits, three binary digits, four binary digits, etc., into symbol waveforms that can be sampled during a process of converting the sample of the waveform from a digital representation to an analog representation. Block 405 can additionally include adjusting a phase offset via phase timing offset component 302 so as to align a symbol transmitted from uplink packet processor 125 with a packet start symbol generated by symbol mapper 115.

Process 400 can continue at block 410, which can include accumulating phase offsets in an accumulator (e.g., accumulator 320). In an example, accumulator 320 can include a phase index and an interpolant that indicates a more refined phase expressed as an offset from phase index (+) 324. Accumulating phase offsets can include utilizing a register to store a phase index (q) 324 and an offset from the phase index as interpolant 322.

Process 400 can continue at block 415, which includes interpolating polyphase constants that are suitable for a phase offset represented by phase index (φ) 324 and interpolant 322. In an example, polyphase filter constants can be linearly interpolated to determine suitable root-raised cosine filter coefficients, Gaussian filter coefficients, finite impulse response filter coefficients for filtering symbols transmitted from symbol mapper 115. In another example, polyphase filter constants can be interpolated utilizing other interpolation approaches, such as Farrow interpolation, Lagrangian interpolation, etc.

Process 400 may continue at block 420, which includes adjusting filter coefficients, e.g., root-raised filter coefficients, Gaussian filter coefficients, finite impulse response filter coefficients etc., based on interpolated polyphase filter constants obtained at block 415.

Process 400 can continue at block 425, which includes applying adjusted symbol filtering coefficients to incoming symbols, such as via delay logic component 350. In an example, a delay logic component can include registers (e.g., 12 registers, 24 registers, 36 registers, etc.) that operate to receive a symbol and apply interpolated root-raised cosine coefficients (c₁, c_{N}) to each of the registers. Samples of a waveform can be shifted in a time sequence through each register (R₁, R₂, R₃, . . . . Rx) based on signals from a reference signal from uplink packet processor 125.

Process 400 can continue at block 430, which can include converting filtered symbols (e.g., root-raised cosine filtered symbols) to an analog representation. Block 430 can include the use of a digital-to-analog converter that accepts samples of a waveform at a rate of 250 megahertz, such as digital-to-analog converter 130.

Process 400 can continue at block 435, which can include modulating analog signals from digital-to-analog converter 130 to a carrier frequency. In an example, block 435 can include mixing analog signals from digital-to-analog converter 130 with a complex sinusoidal signal from local oscillator 140. An example, a complex sinusoidal signal can include a quadrature-phase signal and an in-phase signal, thus providing quadrature-phased and in-phase (I/Q) components of a modulated carrier signal.

Process 400 can continue at block 440, which includes amplifying and transmitting the signal modulated at 435. Block 440 can additionally include amplifying the modulated signal for transmission by antenna 170 to be received at, for example, satellite 180.

Computers or processors utilized by, for example, uplink packet processor 125, may include one or more processors coupled to a memory. A computer memory can include one or more forms of computer readable media, and stores instructions executable by a processor for performing various operations, including as disclosed herein. For example, the computer can be a generic computer with a processor and memory as described above and/or a controller, or the like for a specific function or set of functions, and/or a dedicated electronic circuit including an ASIC that is manufactured for a particular operation, e.g., an ASIC for processing radio data. In another example, computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

As used herein, a computer memory can be of any suitable type, e.g., EEPROM, EPROM, ROM, Flash, hard disk drives, solid state drives, servers, or any volatile or non-volatile media. The memory can store data. The memory can be a separate device from the computer, and the computer can retrieve information stored in the memory. Alternatively, or additionally, the memory can be part of the computer, i.e., as a memory of the computer or firmware of a programmable chip.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
a phase timing offset component that generates a first signal to indicate an offset of a first symbol from a reference signal;
an accumulator component that combines the offset of the first symbol with a first phase increment based on the reference signal;
a memory that stores a first shaping parameter to apply to the first symbol based on the first phase increment; and
an interpolator that modifies the first shaping parameter for the first phase increment to adjust for the offset of the first symbol.

2. The system of claim 1, wherein the reference signal is a clock signal that initiates a sampling interval to sample a waveform representing the first symbol.

3. The system of claim 2, wherein the phase timing offset component additionally generates a second signal to indicate a timing delay of a clock cycle from the clock signal.

4. The system of claim 1, wherein the accumulator component combines the offset of the first symbol with the first phase increment of the reference signal into a digital word for storage by the memory.

5. The system of claim 1, wherein the first shaping parameter to apply to the first symbol includes a polyphase filter constant.

6. The system of claim 5, wherein the polyphase filter constant operates to reduce intersymbol interference between the first symbol and a second symbol.

7. The system of claim 5, wherein the polyphase filter constant determines a root raised cosine filter.

8. The system of claim 1, wherein the first symbol is a complex sinusoidal signal from a 16-quadrature amplitude modulator.

9. The system of claim 1, wherein the interpolator interpolates between the first shaping parameter that is based on the first phase increment and a second shaping parameter that is based on a second phase increment.

10. The system of claim 1, wherein the interpolator executes a linear interpolation between the first shaping parameter for the first phase increment and a second shaping parameter for a second phase increment.

11. The system of claim 1, wherein the interpolator executes Farrow interpolation between the first shaping parameter for the first phase increment and a second shaping parameter for a second phase increment.

12. The system of claim 1, wherein the first shaping parameter results in a signal-to-noise ratio of a waveform representing the first symbol of at least 40 decibels.

13. A method, comprising:
generating a first signal to indicate an offset of a first symbol from a reference signal;
combining the offset of the first symbol with a first phase increment based on the reference signal;
storing a first shaping parameter to apply to the first symbol based on the first phase increment; and
interpolating the first shaping parameter for the first phase increment to adjust for the offset of the first symbol.

14. The method of claim 13, wherein the reference signal is a clock signal that initiates a sampling interval to sample a waveform representing the first symbol.

15. The method of claim 13, further comprising generating a second signal to indicate a timing delay of a clock cycle from the reference signal.

16. The method of claim 13, wherein the first shaping parameter to apply to the first symbol includes a polyphase filter constant.

17. The method of claim 16, wherein the polyphase filter constant results in a signal-to-noise ratio of the first symbol to at least 40 decibels.

18. The method of claim 16, wherein the polyphase filter constant determines a root raised cosine filter.

19. The method of claim 13, wherein the first symbol is a complex sinusoidal signal generated by a 16-quadrature amplitude modulator.

20. The method of claim 13, wherein interpolating the first shaping parameter for the first phase increment includes linearly interpolating between the first shaping parameter that is based on the first phase increment and a second shaping parameter that is based on a second phase increment.
